(19) United States
(12) Patent Application Publication
(10) Pub. No.: US 2001/0010109 A1
(43) Pub. Date: Aug. 2, 2001

(54) Spring element, especially for apparatus for raising and lowering windowpanes of motor vehicles

(75) Inventor: Sebastian Jager, Hannover (DE)

Correspondence Address: ROBERT W. BECKER & ASSOCIATES, 11896 N. Highway 14, Suite B, Tijeras, NM, 87059, US

(73) Assignee: Optimer Polymer-Technik Gmbh, Osterode (DE)

(21) Appl. No.: 09/728,872

(22) Filed: Dec. 1, 2000

(30) Foreign Application Priority Data
Dec. 4, 1999 (DE) 199 58 036.7

(51) Int. Cl. E05F 1/00

(52) U.S. Cl. 16/199

(57) ABSTRACT

A spring element, especially a torsion dampener, is provided, especially for apparatus for raising and lowering windowpanes of motor vehicles. The spring element includes an outer ring, and an inner ring that is concentric to the outer ring. At least one spoke-like element monolithically interconnects the outer and inner rings, with the outer ring, the inner ring and the spoke-like elements all being made of the same material. At least one member of elastomeric material is disposed between and adheres to both the outer and the inner ring. The material of the outer ring, the inner ring and the spoke-like elements is considerably harder than that of the member of elastomeric material.

### BACKGROUND OF THE INVENTION

The present invention relates to a spring element, preferably a torsion dampener, which is intended in particular for apparatus for raising and lowering windowpanes of motor vehicles.

The present invention also relates to spring elements of the aforementioned type that have a hard and rigid outer ring and a similar inner ring, with the two rings being concentric to one another and having disposed between them one or more members of rubber or rubber-like polymeric material that adheres to the two rings.

With heretofore known spring elements of this general configuration, for example sleeve springs, the inner ring on the one hand and the outer ring on the other hand are separately produced components that are then placed in a manufacturing mold to finish the spring element by introducing the rubber into the space between the two rings and then hardening or vulcanizing the material.

With such a manufacture, it is necessary to produce and handle annular members having different sizes. In addition, the spring characteristic of such known spring elements is practically a function of the rubber or other material that is disposed between the rings.

It is therefore an object of the present invention to improve the manufacture of spring elements of the aforementioned type, and in addition to be able to influence the spring characteristic of the rubber member or members disposed between the springs.

### BRIEF DESCRIPTION OF THE DRAWING

This object, and other objects and advantages of the present invention, will appear more clearly from the following specification in conjunction with the accompanying schematic drawing, in which:

FIG. 1 shows a worm gear drive as a component of an apparatus for raising and lowering vehicle windows, and includes one exemplary embodiment of the inventive spring element;

FIG. 2 is a cross-sectional view through the gear mechanism of FIG. 1;

FIG. 3 is a plan view of a portion of the inner and outer rings of the inventive torsion dampener; and

FIG. 4 is a radial cross-sectional view through the inner and outer rings of a modified inventive torsion dampener.

### SUMMARY OF THE INVENTION

The spring element of the present invention is characterized primarily in that the inner and outer rings are monolithically interconnected by one, and preferably by several, spoke-like elements. In this connection, the elements expediently have a thickness that is considerably less than that of the rings. In addition, the elements can be provided with one or more breaking points in order under certain conditions to again sever the connection produced during the manufacture of the spring element. Such a measure can be dispensed with if the elements have such a form that they can experience a change in shape during relative movements of the two rings. Thus, for example, it is possible to provide the elements with a wave-like or zigzagged shape.

In conformity with the inventive concept, the elements can be embedded in the rubber member or members that are disposed between the rings although it is also possible for the elements and rubber members to follow one another in the circumferential direction of the rings.

The inventively provided element connection between the two rings facilitates the handling and arrangement during the fabrication of the spring element, and in particular during manipulation in the vulcanization mold. In addition, the spring characteristics of the aforementioned spoke-like connecting elements and of the soft elastic elements can compliment one another, and in particular also due to the damping quality of the rubber.

By means of a suitable shaping of the rubber and of the connecting elements, the spring element can be stressed axially, radially and rotationally. It is also possible to use it as a journal bearing. However, the inventive spring element is preferably intended for use as a dampened, rotationally elastic connection, especially for the movement or lifting drive for windows of motor vehicles.

Within the context of the present invention, the term rubber also includes rubber-like polymeric materials, in other words, elastomeric materials. These materials should obtain a hardness of about 30-70 Shore A.

The hard and rigid rings should preferably be made of a polymeric material that can be injection molded and that after shaping becomes hard, for example a thermoplastic polymer.

Further specific features of the present invention will be described in detail subsequently.

### DESCRIPTION OF PREFERRED EMBODIMENTS

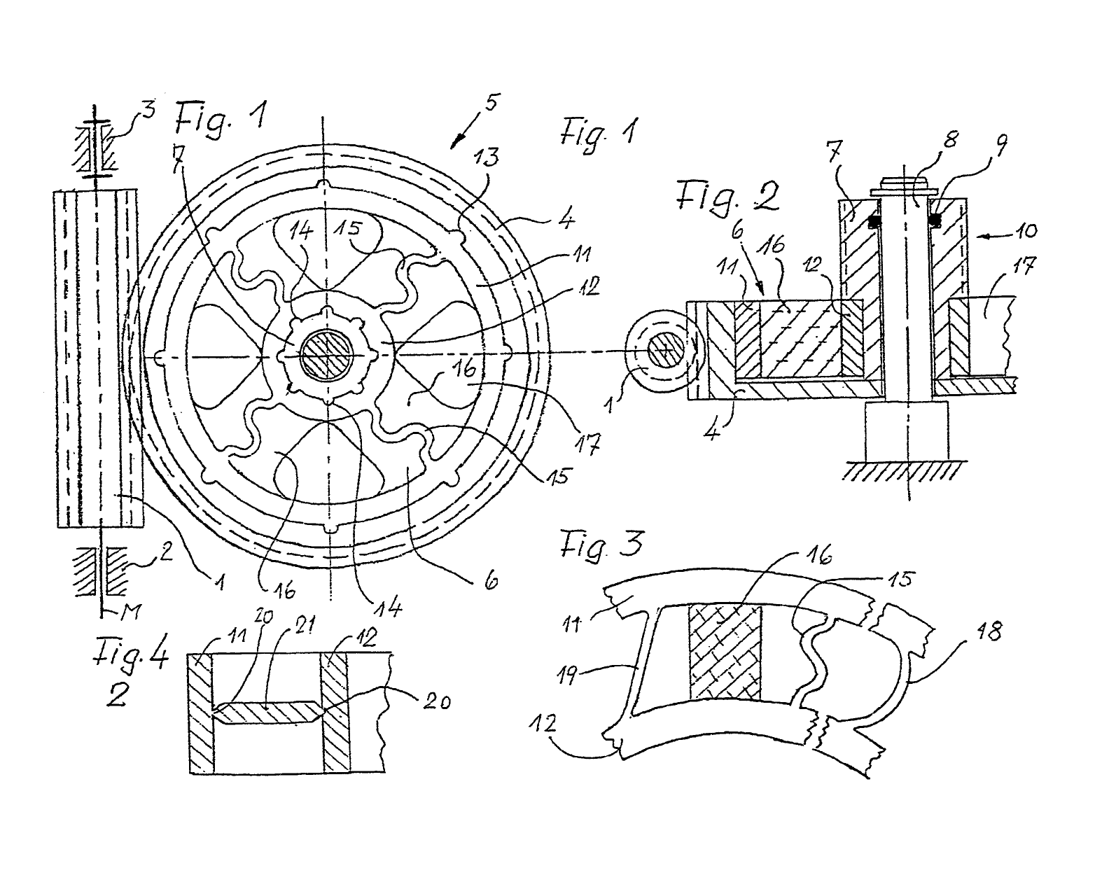

Referring now to the drawing in detail, in FIG. 1 the drive motor or a suitable operating crank of the apparatus for raising and lowering the window of a vehicle engages at M on the shaft of an endless screw 1 with which are associated a radial bearing 2 and a radial and axial or thrust bearing 3. The endless screw 1 drives the rigid rim 4 of a worm gear 5, which is operatively connected via a torsional vibration dampener 6 with a driving or coupling shaft 7 that is rotatably mounted on a stationary pin 8; the coupling shaft 7 has an O-ring seal 9, and its upper end 10 is provided for the output. For this purpose, the upper end 10 can be provided with teeth or a toothed wheel for driving the subsequent adjustment elements.

The torsion dampener 6 has an outer ring 11 and an inner ring 12. Distributed over the outer periphery of the outer ring 11 are projections 13 that engage in corresponding recesses of the rim 4. In contrast, the inner ring 12 has recesses into which engage corresponding projections 14 of the coupling shaft 7. With such a positive connection, an adequately rigid connection is provided, not only with regard to the outer ring 11 but also with regard to inner ring 12.

To produce the torsion dampener the two rings 11, 12 are formed in common by injection molding or the like. So that in so doing a single, cohesive product can result, the two rings 11, 12 are connected by s-shaped elements 15 that extend in a generally radial direction and are uniformly distributed over the periphery of the ring. In this connection, 3-6 elements are generally sufficient to hold the two rings 11, 12 together or to join them concentrically. The thus resulting double ring with the elements 15 is placed in a vulcanization mold where rubber or the like is supplied, and preferably in such a way that it enters into a fixed connection with the adjoining parts 11, 12 and 15. In the embodiment illustrated in FIG. 1, an approximately radially extending rubber member 16 is associated with each element 15; in otherwords, each element 15 is preferably centrally disposed in such a member.

It is to be understood that with a torsion dampener provided in this manner, hard springs are provided by the forming of the elements 15, and soft springs are provided in the form of the inherently damping rubber members 16, whereby the elements 15 permit a deformation due to their s-shape.

It should be noted that with the configuration of FIG. 1, it is also possible to fill the free spaces 17 located between the rubber members 16 with rubber or the like.

As can be seen from FIG. 3, the rubber member 16 on the one hand and the elements 15 on the other hand are separated from one another. Also recognizable are elements 15 that have other than an s-shape. For instance, provided are a curved element 18 and a linear or straight element 19 that however extends at an angle.

The separated arrangement of FIG. 3 has the additional advantage that for example after the formation of the rubber member 16 all or a portion of the elements 15, 18, 19 can be mechanically cut through in order in this manner to achieve particular effects with regard to the spring characteristics.

An automatic separation of the aforementioned type can also be achieved by providing the element 21 with breaking points 20. With an appropriate deformation of the dampener, a corresponding great stress takes place on the elements 21, leading to a desired separation of the elements 21 from the rings 11, 12.

Since the rings 11, 12 can readily be produced in a mold, it is possible to also integrally produce the rim 4 and the coupling shaft 7 during such molding. It is even possible to immediately form the O-ring 9 thereon.

The specification incorporates by reference the disclosure of German priority document 199 58 036.7 of Dec. 4, 1999.

The present invention is, of course, in no way restricted to the specific disclosure of the specification and drawing, but also encompasses any modifications within the scope of the appended claims.

What I claim is:

1. A spring element comprising:
an outer ring;
an inner ring that is concentric to the outer ring;
at least one spoke-like element that monolithically interconnects the outer ring and the inner ring, wherein the outer ring, the inner ring and the at least one spoke-like element are made of the same material; and
at least one member of elastomeric material that is disposed between and adheres to both of said outer and inner rings, wherein the material of said inner ring, said outer ring, and said at least one spoke-like element is considerably harder than that of said at least one member.

2. A spring element according to claim 1, wherein said at least one spoke-like element has a thickness that is considerably less than a thickness of said outer and inner rings.

3. A spring element according to claim 1, wherein at least a portion of a direction of said at least one spoke-like element deviates from a radial direction prescribed by said outer and inner rings.

4. A spring element according to claim 3, wherein said at least one spoke-like element, when viewed in an axial direction of said spring element, has a curved, s-shaped, or wave-shaped configuration.

5. A spring element according to claim 1, wherein said at least one spoke-like element is provided with at least one breaking point that breaks upon or during operation of said spring element.

6. A spring element according to claim 1, wherein said at least one spoke-like element is embedded in said at least one member of elastomeric material.

7. A spring element according to claim 1, wherein said at least one spoke-like element is spaced from said at least one member of elastomeric material such that said at least one spoke-like element can be mechanically cut without damaging or destroying said at least one member.

8. A spring element according to claim 6, wherein said at least one member of elastomeric material is arranged in a spoke-like manner.

9. A spring element according to claim 1, which is in the form of a torsion dampener for a worm gear of a worm drive, wherein elements of said drive that are operatively connected to said outer and inner rings are monolithically formed on said rings during manufacture of the latter.

10. A spring element according to claim 1, wherein said outer and inner rings are provided with at least one of projections and recesses that correspond with appropriate recesses and projections of adjacent elements to form a positive connection.
